(19) United States
(12) Patent Application Publication
(10) Pub. No.: US 2007/0072088 A1
(43) Pub. Date: Mar. 29, 2007

(54) Composition for hologram recording media, hologram recording medium and method for producing the same, hologram recording method and hologram reproducing method

(75) Inventors: Masatoshi Yumoto, Shizuoka (JP); Naoto Yanagihara, Shizuoka (JP); Hirotaka Matsumoto, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/522,967

(22) Filed: Sep. 19, 2006

(30) Foreign Application Priority Data
Sep. 20, 2005 (JP) 2005-272528

(51) Int. Cl. G03H 1/04; G03C 1/00

(52) U.S. Cl. 430/1; 430/2; 430/281.1

(57) ABSTRACT

The objects of the present invention are to provide a composition for hologram recording media that can produce high-quality hologram recording media efficiently with less time-consuming and without being affected by moisture, to provide volume-type hologram recording media that are adapted to high-density recording, to provide a method for producing the volume-type hologram recording media that can produce efficiently the hologram recording media with lower cost, and also to provide a hologram-recording method and to provide a hologram-reproducing method that utilizes the hologram recording media respectively. Accordingly, the present invention relates to a composition for hologram recording media, comprising a polymerizable monomer, a photopolymerization initiator, a non-polymerizable compound, and an organic gelling agent and the like.

### BACKGROUND OF THE INVENTION

1. Field of the Invention

The present invention relates to a composition for hologram recording media which can lead to production of high-quality hologram recording media with shorter periods and higher efficiency, a hologram recoding medium capable of recording high-density images due to the composition and also an effective production method thereof, and a hologram recording method and a hologram reproducing method by use the hologram recording media.

2. Description of the Related Art

A photosensitive composition for hologram-recording media is proposed that is utilized for producing volume-type hologram recording media having a hologram recording layer between two substrates, in which the composition is formed mainly of a radically polymerizable monomer, a binder polymer, a radically photopolymerization initiator, and a sensitizing dye, and is founded on the refractive-index difference between the radically polymerizable monomer and the binder polymer (see Japanese Patent Application Laid-Open UP-A) No. 0643634). When a film, formed from the photosensitive composition described above, is exposed with an interference light, radical polymerization occurs at sites where being exposed intensively, then the radically polymerizable monomer represents a concentration gradient and a diffusion migration from sites being less exposed to sites being exposed intensively. Consequently, there appear dense and dilute sites of the radically polymerizable monomer depending on the intensity of the interference light, which provides the sites with different refractive indices. However, such materials are conventionally formed into films by coating processes using solvents, thus film thickness of the hologram recording layers tends to be lower and insufficient for multiplicity of hologram recording.

As for the other photosensitive compositions for the volume-type hologram recording media, for example, a composition is proposed that contains an NCO-ended prepolymer and polyol or a bifunctional epoxide and tetrafunctional mercaptan as a polymer matrix precursor. In this case, the polymer matrix precursor is sandwiched between two base materials in a predetermined thickness, then the polymer is reacted to form a polymer matrix to thereby prepare a hologram recording medium without any coating processes with solvents (see U.S. Pat. No. 6,482,551); however, there exists such a problem as the prepolymer polymerization is time-consuming and likely to be affected by environmental moisture.

### SUMMARY OF THE INVENTION

The present invention purposes to solve the problems described above and to achieve the objects described below. That is, an object of the present invention is to provide a composition for hologram recording media that can produce high-quality hologram recording media efficiently with less time-consuming and without being affected by moisture due to employing organic gelling agents. Another object of the present invention is to provide volume-type hologram recording media that are adapted to high-density recording, and still another object of the present invention is to provide a method for producing the volume-type hologram recording media that can produce efficiently the hologram recording media with lower cost, due to employing the composition for hologram recording media. Another object of the present invention is to provide a hologram recording method and still another object is to provide a hologram reproducing method that utilize the hologram recording media respectively.

The objects of the invention described above can be attained by the following means. The composition for hologram recording media according to the present invention is characterized in that it comprises at least a polymerizable monomer, a photopolymerization initiator, a non-polymerizable compound and an organic gelling agent. The composition for hologram recording media may bring about the production of high-quality hologram recording media efficiently with less time-consuming and without being affected by moisture due to employing the organic gelling agent.

The first embodiment of the hologram recording medium according to the present invention is characterized in that the hologram recording medium comprises a hologram recording layer that contains the composition for hologram recording media according to the present invention.

The second embodiment of the hologram recording medium according to the present invention is characterized in that the hologram recording medium comprises a first substrate, a second substrate, and a hologram recording layer on the second substrate that can record information by use of holography, in which the hologram recording layer is formed from the composition for hologram recording media according to the present invention.

The hologram recording medium according to the present invention may lead to high-quality products capable of high-resolution recording due to employing the composition for hologram recording media according to the present invention.

In the method for producing a hologram recording medium according to the present invention, a hologram recording medium is produced that comprises a first substrate, a second substrate, and a hologram recording layer on the second substrate that can record information by use of holography, the method is characterized in that it comprise at least forming a hologram recording layer by heating the composition for hologram recording media at above the gelling temperature of the organic gelling agent, followed by disposing the composition between the first substrate and the second substrate.

In the method for producing a hologram recording medium according to the present invention, the composition for hologram recording media is heated above the gelling temperature to thereby turn into a flowable liquid; therefore, the composition may be easily disposed and spread between two substrates into a predetermined thickness. Then the composition is cooled below the gelling temperature, consequently, the composition for hologram recording media turns from a liquid state into a gel state thereby to form a hologram recording layer. In general, the liquid state may promptly change into the gel state through a phase transition, thus the hardening may occur rapidly and the hologram recording medium may be produced effectively.

The first embodiment of the hologram recording method according to the present invention is characterized in that an informing light and a reference light are irradiated, and information is recorded on the hologram recording layer by means of the interference pattern generated by the interference between the informing light and the reference light.

In the first embodiment of the hologram recording method according to the present invention, exceptionally high density recording can be realized, since the informing light and the reference light are irradiated using the hologram recording medium according to the present invention and the information is recorded on the hologram recording layer by means of the interference pattern generated by the interference between the informing light and the reference light.

The second embodiment of the hologram recording method according to the present invention is characterized in that a coaxial light beam of the informing light and the reference light is irradiated onto the hologram recording medium of the present invention, and information is recorded on the hologram recording layer by means of the interference pattern generated by the interference between the informing light and the reference light.

In the second embodiment of the hologram recording method according to the present invention, exceptionally high density recording can be realized, since the coaxial light beam of the informing light and the reference light is irradiated onto the hologram recording medium of the present invention, and information is recorded on the hologram recording layer by means of the interference pattern generated by the interference between the informing light and the reference light.

The hologram reproducing method according to the present invention is characterized in that the information is reproduced by way of irradiating the reference light onto the interference pattern of the hologram recording layer to which the information being recorded by the inventive hologram recording method described above.

In the hologram reproducing method according to the present invention, the interference pattern of the hologram recording layer to which the information being recorded by the inventive hologram recording method can be efficiently exactly read thereby the high density information can be reproduced.

### BRIEF DESCRIPTION OF THE DRAWINGS

FIG. 1 is a schematic cross section that shows partially a hologram recording medium.

FIG. 2 is a schematic cross section that shows partially a hologram recording medium of disc-type.

FIG. 3 is a schematic cross section that shows exemplarily a hologram recording medium.

FIG. 4 is a schematic cross section that shows exemplarily a hologram recording medium of an embodiment in accordance with the present invention.

FIG. 5 is an explanatory view that shows exemplarily an optical system around a hologram recording medium.

FIG. 6 is a block diagram that shows exemplarily an entire construction of a hologram recording and reproducing apparatus of the second embodiment according to the present invention.

### DESCRIPTION OF THE PREFERRED EMBODIMENTS

Composition for Hologram Recording Media

The composition for volume-type hologram recording media according to the present invention comprises essentially (A) an organic gelling agent, (B) a polymerizable monomer, (C) a photopolymerization initiator, (D) a non-polymerizable compound, and optionally (E) an additive and other components.

(A) Organic Gelling Agent

The organic gelling agent as used herein refers to heat-reversible physical gels that represent a flowable sol upon heating meanwhile turn into a gel upon cooling by action other than covalent bonding, such as hydrogen bonding, van der Waals attraction, pi-pi stacking, electrostatic interaction, coordinate linkage etc. The organic gelling agent, which may be of lower molecular-weight compounds or polymer compounds, may be selected properly considering the polymerizable monomer and the other components included in the composition for hologram recording media. Specific examples of the organic gelling agent include 1,2,3,4-dibenzylidene-D-sorbitol, 12-hydroxystearic acid, N-lauroyl-L-glutamic acid-α,γ-bis-n-butylamide, cholesterol derivatives, cholic acid derivatives, 2,3-bis-n-hexadesiloxyanthracene, urea derivatives, gluconamide derivatives, N,N′-didodecanoyl-trans-(1R,2R)-1,2-cyclohexanediamine, gelatin, polyvinyl alcohol, polyacrylic acid etc. As for the details of these compounds, the following literatures are of reference: Surface, 36, 6, p 291 (1998); Chem. Rev., 1997, 97, 3133; JP-A No. 2004-262856; and Gel Handbook, N.T.N., 1997.

It is preferred that the gelling temperature is 30° C. to 80° C., more preferably 40° C. to 70° C., in which the gelling temperature is defined as the temperature at which the inventive composition for the hologram recording media comes to non-flowable in a test tube even when being reversed. When the gelling temperature is below 30° C., the composition is likely to be a sol state at room temperature, thus the hologram recording media may not be produced efficiently, and when it is above 80° C., the energy or operation efficiency may be inappropriate at liquidizing the composition for the hologram recording media.

The gelling temperature depends on the content and species of the organic gelling agent, and the species of the components in the composition for hologram recording media; it is possible to adjust the gelling temperature by selecting properly the organic gelling agent from those described above.

The content of the organic gelling agent may be properly defined in relation to the gelling temperature; preferably, the content is 0.1% by mass to 10% by mass based on the entire weight of the composition for hologram recording media, more preferably 0.2% by mass to 5% by mass. When the content is less than 0.1% by mass, the gelatinization may not be induced, and when it is more than 10% by mass, such problems as poor solubility and higher gelling temperatures may reduce the efficiency.

(B) Polymerizable Monomer

The polymerizable monomer may be properly selected depending on the purpose; examples thereof include radically polymerizable monomers having an unsaturated bond such as acrylic and methacrylic groups and cationic polymerization monomers having an ether structure such as epoxy or oxetane ring. These monomers may be monofunctional or polyfunctional and also be one utilizing a photo-crosslinking reaction.

Examples of the radically polymerizable monomers include acryloyl morpholine, phenoxyethylacrylate, isobornylacrylate, 2-hydroxypropylacrylate, 2-ethylhexylacrylate, 1,6-hexanediol diacrylate, tripropyleneglycol diacrylate, neopentylglycol PO modified diacrylate, 1,9-nonandiol diacrylate, hydroxylpivalic acid neopentylglycoldiacrylate, EO modified bisphenol A diacrylate, polyethyleneglycol diacrylate, pentaerythritol triacrylate, pentaerythritol tetraacrylate, pentaerythritol hexaacrylate, EO modified glycerol triacrylate, trimethylolpropane triacrylate, EO modified trimethylolpropane triacrylate, 2-naphtho-1-oxyethylacrylate, 2-carbazoyl-9-ylethylacrylate, (trimethylsilyloxy)dimethylsilyl propylacrylate, vinyl-1-naphthoate, N-vinylcarbazol, 2,4,6-tribromophenylacrylate, pentabromophenylacrylate, phenylthioethylacrylate and tetrahydrofurfurylacrylate.

Examples of the cationic polymerization monomers include bisphenol A epoxy resins, phenolnovolac epoxy resins, glycerol triglycidylether, 1,6-hexaneglycidylether, vinyltrimethoxysilane, 4-vinylphenyl trimethoxysilane, gamma-methacryloxy propyltriethoxysilane and compounds expressed by the formulas (A) to (F) below. These may be used alone or in combination of two or more. 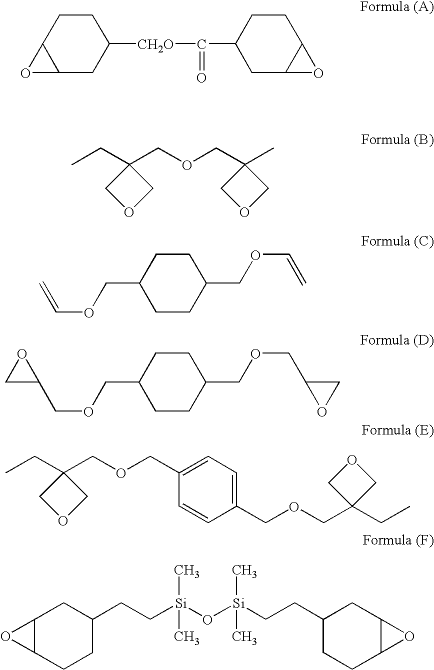
(C) Photopolymerization Initiator

The photopolymerization initiator may be selected from those sensitive to the recording light and capable of inducing a radical polymerization reaction; examples thereof include 2,2′-bis(o-chlorophenyl)-4,4′,5,5′-tetraphenyl-1,1′-biimidazole, 2,4,6-tris(trichloromethyl)-1,3,5-triazine, 2,4-bis(trichloromethyl)-6-(p-methoxyphenylvinyl)-1,3,5-triazine, benzoin, 2-hydroxy-2-methyl-1-phenylpropane-2-one, benzophenone, thioxanthone, 2,4,6-trimethylbenzoyldiphenylacyl phosphineoxide, triphenylbutylborate tetraethylammonium, bis(η⁵-2,4-cyclopentadiene-1-yl)-bis[2,6-difluoro-3-(1H-pyrrole-1-yl)]phenyl titanium, compounds having an optical absorption site and an active site to generate a free radical as described in JP-A No. 2005-49608. Among these, preferable are 2,2′-bis(o-chlorophenyl) 4,4′,5,5′-tetraphenyl-1,1′-biimidazole, triphenylbutylborate tetraethylammonium, and bis(η⁵-2,4-cyclopentadiene-1-yl)-bis[2,6-difluoro-3-(1H-pyrrole-1-yl)]phenyl titanium. These may be used alone or in combination of two or more. Furthermore, sensitizing dyes may be combined as a sensitizing agent considering the wavelength of irradiating light. The content of the photopolymerization initiator is preferably 0.3 to 4% by mass based on the solid content in the composition of hologram recording media, more preferably 0.5 to 3% by mass.

The sensitizing dyes may be conventional compounds described in Research Disclosure, vol. 200, December 1980, Item 20036; Sensitizer, pp. 160-163, Kodansha Ltd., ed. Katsumi Tokumaru and Shin Ohgawara, 1987.

Specific examples of the sensitizing agents are 3-ketocoumarin compounds described in JP-A No. 58-15603; thiopyrylium salts described in JP-A No. 58-40302; naphthothiazole merocyanine compounds described in Japanese Examined Patent Publication UP-B) Nos. 59-28328 and 60-53300; and merocyanine compounds described in JPB Nos. 61-9621 and 62-3842, JP-A Nos. 59-89303 and 60-60104.

Furthermore, the sensitizing agents may be the dyes described in Functional Dye Chemistry, 1981, CMC Publishing Co., pp. 393-416; Color Material, 60 (4), 212-224 (1987); more specific are cationic methine dyes, cationic carbonium dyes, cationic quinonimine dyes, cationic indoline dyes and cationic styryl dyes.

Still furthermore, the sensitizing agents may keto dyes such as coumarin dyes including ketocoumarin and sulfocoumarin, merostyryl dyes, oxonol dyes and hemioxonol dyes; non-keto dyes such as non-keto polymethine dyes, triarylmethane dyes, xanthen dyes, anthracene dyes, rhodamine dyes, acridine dyes, aniline dyes and azo dyes; non-keto polymethine dyes such as azomethine dyes, cyanine dyes, carbocyanine dyes, dicarbocyanine dyes, tricarbocyanine dyes, hemicyanine dyes and styryl dyes; and quinoninine dyes such as azine dyes, oxazin dyes, thiazin dyes, quinoline dyes and thiazole dyes. The sensitizing agents may be used alone or in combination of two or more.

The content of the sensitizing dyes is preferably 0.3% by mass to 4% by mass based on the total solid content in the composition for hologram recording media, more preferably 0.5% by mass to 3% by mass.

(D) Non-Polymerizable Compound

The non-polymerizable compound as used herein is compounds non-incorporatable into polymers upon photopolymerization, and is added into the composition in order to adjust the refractive index. The compound may be a binder polymer or an oligomer. In the volume hologram recording, interference stripes generated by light interference are recorded as stripes having different refractive indices. The polymerizable monomer tends to diffuse into lighter portions and polymerize at the lighter portions thus the resulting polymer portions typically represent higher refractive indices than the monomer portions, meanwhile compounds having different refractive indices, preferably lower refractive indices, are required to build up at the darker portions.

Examples of the binder polymer or oligomer include copolymers of unsaturated acids such as (meth)acrylic acid or itaconic acid and alkyl(meth)acrylate, phenyl(meth)acrylate, benzyl(meth)acrylate, styrene or alpha-methylstyrene; polymers of alkylmethacrylate. or alkylacrylate such as polymethylmethacrylate; copolymers of alkyl(meth)acrylate and acrylonitrile, vinyl chloride, vinylidene chloride, styrene etc.; copolymers of acrylonitrile and vinyl chloride or vinylidene chloride; modified celluloses having carboxyl group at the side chain; polyethylene oxide; polyvinyl pyrrolidone; novolac resins obtained by condensation reaction of phenol, o-, m- or p-cresol and/or xylenol and aldehyde, acetone; polyethers of epichlorohydrin and bisphenol A; soluble nylon, polyvinylidene chloride; chlorinated polyolefins; copolymers of vinyl chloride and vinyl acetate; polymers of vinyl acetate; copolymers of acrylonitrile and styrene; copolymers of acrylonitrile, butadiene and styrene; polyvinyl alkylethers; polyvinyl alkylketones; polystyrenes; polyurethanes; polyethylene terephthalateisophthalate; acetylcelluloses; acetylpropyoxycelluloses; acetylbutoxycelluloses; nitrocelluloses; celluloid; polyvinyl butyral; epoxy resins; melamine reisns; formaldehyde resins; and siloxanes. When one or both of “acryl” and “methacryl” are referred in this specification, the term “(meth)acryl” is sometimes used. The molecular weight of these binder polymers or oligomers is preferably 500 to 100000, more preferably 1000 to 30000.

Examples of the non-polymerizable compound other than the binder polymers or oligomers described above are fatty esters, phosphate esters, hydrocarbon compounds and urethane compounds.

The content of these non-polymerizable compounds is preferably 10% by mass to 95% by mass based on the total solid content of the composition for hologram recording media, more preferably 35% by mass to 90% by mass.

(E) Additive

A polymerization inhibitor or antioxidant may be added in order to improve the preservation stability of the recording layers. The polymerization inhibitor or antioxidant may be, for example, hydroquinone, p-benzoquinone, hydroquinone monomethylether, 2,6-di-tert-butyl-p-cresol, 2,2′-methylenebis(4-methyl-6-tert-butylphenol), triphenylphosphite, trisnonyl phenylphosphite, phenothiazine or N-isopropyl-N′-phenyl-p-phenylene diamine.

The content of the additives described above is less than 3% by mass based on the entire mass of the polymerizable monomers used for the composition for the hologram recording media. When the content is more than 3% by mass, the polymerization tends to delay or not proceed in some cases.

Hologram Recording Medium

The hologram recording medium according to the present invention comprises at least a first substrate, a second substrate, and a hologram recording layer on the second substrate capable of recording information by the holography, and also as required a filter layer, a gap layer and other layers. The details of the hologram recording medium according to the present invention will be explained with reference to specific embodiments below.

The hologram recording medium according to the present invention may be of relatively thin plane holograms to record two-dimensional information or volume holograms to record numerous information such as stereo images and of transmissive or reflective type. The recording mode of the hologram may be, for example, of amplitude hologram, phase hologram, brazed hologram or complex amplitude hologram.

Hologram Recording Layer

The hologram recording layer may be formed by heating the inventive composition for the hologram recording media at above the gelling temperature of the organic gelling agent followed by disposing it between the first substrate and the second substrate. The hologram recording layer, to which information being recorded by means of holography, may record at much higher density by use of the inventive composition for the hologram recording media as the essential material that alters optical properties such as the absorption constant and refractive index depending on the intensity of irradiated electromagnetic wave having a certain wavelength.

The disposing of the composition for the hologram recording media may be carried out, for example, by attaching to the substrate a gasket to support the composition for the hologram recording media, heating the composition for the hologram recording media at above the gelling temperature of the organic gelling agent to form a liquid state by solation then injecting into the space defined by the gasket, followed by cooling the composition for the hologram recording media to below the gelling temperature of the organic gelling agent to thereby harden and dispose between the two substrates.

Glasses described below are typically utilized for the substrate; plastic materials transparent for irradiated light and utilized for recording data may be employed in addition to the glasses, such as polycarbonates, poly(methylmethacrylate), and open circular polymers of cyclic olefin. Furthermore, the disposing of the composition for the hologram recording media may be carried out through arranging a spacer between the two substrates so as to form the hologram recording layer in an intended thickness.

Furthermore, the composition for hologram recording media may be deposited in the space provided by the gasket by way of mounting the composition using a dispenser or spraying thereof.

The composition for hologram recording media contains the organic gelling agent that can cause gelatinization of the composition including the polymerizable monomer etc., therefore, it is difficult to dispose the composition between the two substrates at below the gelling temperature due to the gel state; however, the composition may be easily disposed between the two substrates at above the gelling temperature due to the flowable state, and also hologram recording media may be produced having the hologram recording layer between the two substrate by virtue that the composition gelatinizes to lose the flowability at below the gelling temperature after disposing the composition between the two substrate. The liquid state may promptly change into the gel state through a phase transition, thus the hardening may occur rapidly and the hologram recording media may be produced effectively. The prompt gelatinization may make possible to dispose the composition in an intended thickness, thus the hologram recording layer may be produced with higher quality to allow high-density recording. It is preferred that the substrates are also preheated to above the gelling temperature for improving the production efficiency still more. The cooling to below the gelling temperature may be carried out by standing to cool or forcing to cool with water, ice etc., preferably by standing to cool in view of gel-formability.

The thickness of the hologram recording layer is preferably 1 μm to 1500 μm, more preferably 100 μm to 700 μm. When the thickness is less than 1 μm, the multiplicity may be difficult, and when more than 1500 μm, the recording layer may be hardly uniformed.

The preferable range of the optical recording layer described above may lead to sufficient S/N ratio even under shift multiplicity of 10 to 300, and the more preferable range may lead to more significant effect.

Whether the hologram recording layer contains or not the organic gelling agent may be determined by the analysis methods described below, for example. From the analysis, it may be determined whether the hologram recording layer is formed from the composition for hologram recording media according to the present invention.
(i) respective components of the composition are separated and evaluated by NMR or liquid chromatography etc.
(ii) respective components of the composition are identified by LC-MS or TLC-MS without separating procedures.
   Hologram Recording Method and Hologram Recording Apparatus

The hologram recording method according to the present invention comprises irradiating an informing light and a reference light having a coherent property onto the hologram recording medium according to the present invention, forming an interference image from the informing light and the reference light, and recording the interference image on the hologram recording medium.

The informing light and the reference light may be irradiated onto the hologram recording medium in a manner that the optical axis of the informing light is coaxial with the optical axis of the reference light, then the interference image generated by the interference between the informing light and the reference light may be recorded on the hologram recording medium.

In the hologram recording apparatus utilized for the hologram recording method according to the present invention, an informing light and a reference light having a coherent property are irradiated onto the hologram recording medium according to the present invention, an interference image is formed from the informing light and the reference light, and the interference image is recorded on the hologram recording medium.

The method or apparatus for recording or reproducing the hologram recording medium according to the present invention may be properly selected depending on the purpose; for example the hologram recording methods and apparatuses are exemplified described in U.S. Pat. Nos. 5,719,691, 5,838,467, 6,163,391 and 6,414,296; US Patent Application Publication No. 2002-136143; JP-A Nos. 2000-98862, 2000-298837, 2001-23169, 2002-83431, 2002-123949, 2002-123948, 2003-43904 and 2004-171611; WO 99/57719, WO02/05270 and WO02/75727.

Specific Embodiments of Hologram Recording Medium and Method According to Present Invention

The first embodiment of the inventive hologram recording medium comprises a laminated layer of the hologram recording layer on at least a support, and is utilized for usual hologram recording in which an informing light and a reference light are irradiated from different directions. The second embodiment of the inventive hologram recording medium is utilized for Collinear system in which the informing light and the reference light are irradiated in a manner that the optical axis of the informing light is coaxial with the optical axis of the reference light, and comprises a first substrate, a second substrate, a hologram recording layer on the second substrate, and a filter layer between the first and second substrates. The first and the second embodiments will be explained successively in the following.

First Embodiment

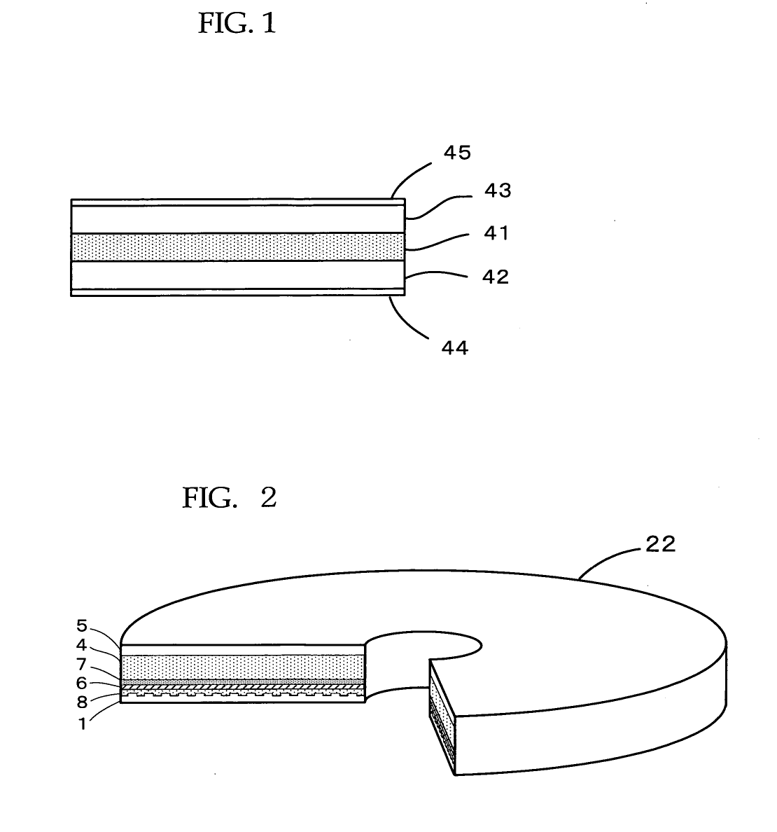

The first embodiment described above may be employed to conventional hologram recording methods; the layer construction may be properly selected depending on the purpose, for example, the layers are constructed such that the hologram recording layer is laminated as mono-layer or two or more layers on the support; or as shown in FIG. 1, recording layer 41 is sandwiched between supports 42 and 43, and antireflective layers 44 and 45 are respectively arranged on supports 42 and 43 as the outermost layers.

Furthermore, a gas-barrier layer etc. may be formed between the recording layer 41 and support 42 or between the recording layer 41 and support 43; a protective layer may be provided on antireflective layers 44 and 45.

Informing Light and Reference Light

The informing light and the reference light may be properly selected depending on the purpose, preferably are a coherent laser light emitted from a light source.

The laser light may be properly selected depending on the purpose; for example, laser lights having one or more wavelengths within 360 nm to 850 nm are exemplified. The wavelength is preferably 380 nm to 800 nm, more preferably 400 nm to 750 nm, most preferably 500 nm to 600 nm which allows to visualize the center of visual region.

When the wavelength is less than 360 nm, clear stereo images may be hardly obtainable, and when more than 850 nm, the interference stripes come to excessively fine for usual photosensitive materials.

The source of the laser light may be properly selected depending on the purpose; examples thereof include solid laser oscillators, semiconductor laser oscillators for blue region, liquid laser oscillators, gas laser oscillators e.g. of argon, He—Cd liquid laser oscillators, double-frequency YAG laser oscillators, He—Ne laser oscillators and Kr laser oscillators. Among these, the gas laser oscillators and semiconductor laser oscillators for blue region are preferable.

The method for irradiating the informing light and the reference light may be properly selected depending on the purpose; for example, one laser light or beam is divided and irradiated for the informing light and the reference light, or two laser lights or beams may be irradiated from different sources.

The irradiating direction of the informing light and the reference light may be properly selected depending on the purpose; for example, the informing light and the reference light may be irradiated from different directions or in a same direction. In addition, the lights may be irradiated in a manner that the optical axis of the informing light and the optical axis of the reference light are coaxial.

Fixing Light

The region onto which the fixing light irradiates may be properly selected depending on the purpose; preferably, the region may be the same region selected optionally to which is intended to record by the informing and reference lights, or the region may be from the outer boundary of the intended recording portion up to 1 μm outside of the boundary. When the fixing light is irradiated to the region beyond 1 μm apart from the outside of the boundary, the adjacent recording regions may be also irradiated, thus the irradiation energy is excessive and non-effective.

The irradiating period of the fixing light may be properly selected depending on the purpose; preferably, the period is 1 ns to 100 ms at the optional region of the recording layer, more preferably 1 ns to 80 ms. When the irradiating period is shorter than 1 ns, the fixing may be insufficient, and when longer than 100 ms, the irradiation results in excessive-energy exposure.

The irradiating direction of the fixing light may be properly selected depending on the purpose; for example, the direction may be the same or different with that of the informing and reference lights irradiating the optional region of the recording layer described above. The irradiating angle is preferably 0° to 60° from normal of the recording layer, more preferably 0° to 40°. When the irradiating angle is outside the range, the fixing may be ineffective.

The wavelength of the fixing light may be properly selected depending on the purpose; preferably, the wavelength is 350 nm to 850 nm at the optional region of the hologram recording layer described above, more preferably 400 nm to 600 nm. When the wavelength is shorter than 350 nm, the material may be decomposed, and when longer than 850 nm, the material may degrade due to higher temperatures.

The light source of the fixing light may be properly selected depending on the purpose; an incoherent light is preferably irradiated, examples thereof are the lights of fluorescent lamps, high-pressure mercury lamps, xenon lamps, light emission diodes, or lights of which the phase being randomized stating from a coherent light e.g. by passing through a forested glass. Among these, preferable are the lights from emission diodes and the lights of which. the phase being randomized stating from a coherent light e.g. by passing through a forested glass.

The irradiation amount of the fixing light may be properly selected depending on the purpose; preferably, the irradiation amount is 0.001 J/cm² to 1 J/cm² at the optional region of the recording layer described above, more preferably 0.01 J/cm² to 0.3 J/cm².

The method for irradiating the fixing light may be properly selected depending on the purpose; for example, the fixing light may be irradiated from the same or different light source with that irradiates the informing and reference lights at the optional region of the recording layer described above.

Hologram Recording Layer

The hologram recording layer is produced by hardening the composition for hologram recording media according to the present invention.

Support

The support may be properly selected depending on the purpose in terms of the shape, configuration, size etc. without limitation; the shape may be disc-like, card-like, flat plate-like or sheet-like; the configuration may be of single-layered or multi-layered; and the size may be appropriately selected depending on the size of the optical recording medium.

The material of the support may be properly selected from inorganic and organic materials. The material of the support may provide the hologram recording medium with a certain mechanical strength; in the case of transparent type where the lights for recording and reproducing enter through the substrate, the material should be transparent at the wavelength region of the employed lights.

Examples of the inorganic material include glasses, quartz glass and silicon. Examples of the organic material include acetate resins such as triacetylcellulose; polyester resins, polyethersulfone resins, polysulfone resins, polycarbonate resins, polyamide resins, polyimide resins, polyolefin resins, acrylic resins, polynorbornene resins, cellulose resins, polyarylate resins, polystyrene resins, polyvinylalcohol resins, polyvinylchloride resins, polyvinilidenechloride resins, polyacrylic resins, polylactic acid, papers with laminated plastic film and synthetic papers. They may be used alone or in combination of two or more. Among these, polycarbonate resins and acrylic resins are preferable in view of formability, optical properties and cost.

The support described above may be appropriately synthesized or commercially available.

The thickness of the support may be properly selected depending on the purpose; preferably, the thickness is 0.1 mm to 5 mm, and more preferably 0.3 mm to 2 mm. When the thickness of the support is less than 0.1 mm, the disk may not resist the distortion of shape during storing, and when the thickness is more than 5 mm, the weight of the disk becomes heavy, thus excessive load may be applied to devices such as driving motors when the disk is rotated by means of them.

Second Embodiment

The second embodiment is utilized for Collinear system in which the informing light and the reference light are irradiated in a manner that the optical axis of the informing light is coaxial with the optical axis of the reference light; and the second embodiment is exemplified by a hologram recording medium that comprises a first substrate, a second substrate, a hologram recording layer on the second substrate, and a filter layer between the first and second substrates.

Hologram Recording Method and Reproducing Method in Second Embodiment

The hologram recording method in the second embodiment is an optical recording method founded on so-called Collinear system in which an informing light and a reference light are irradiated as a coaxial light beam, and information is recorded on the hologram recording layer by an interference pattern generated by the interference between the informing light and the reference light.

The reproducing method may be properly selected depending on the purpose; for example, the same light with the reference light may be irradiated onto the interference image formed in the hologram recording layer by the hologram recording method described above, thereby to reproduce the recorded information corresponding to the interference image.

In the hologram recording method and the reproducing method of the second embodiment, the informing light with a two-dimensional intensity distribution and the reference light with almost the same intensity to that of the informing light are superimposed inside the hologram recording layer, the resulting interference pattern formed inside the hologram recording layer induces a distribution of the optical properties of the recording layer to thereby record such distribution as an information. On the other hand, when the recorded information is to be read (reproduced), only the reference light is irradiated onto the recording layer from the same direction to that irradiated at the time of recording, a light having a intensity distribution corresponding to the distribution of the optical property formed inside the recording layer is emitted from the recording layer as a diffracted light.

The hologram recording method and the reproducing method of the second embodiment may be carried out by use of the hologram recording and reproducing apparatus explained below.

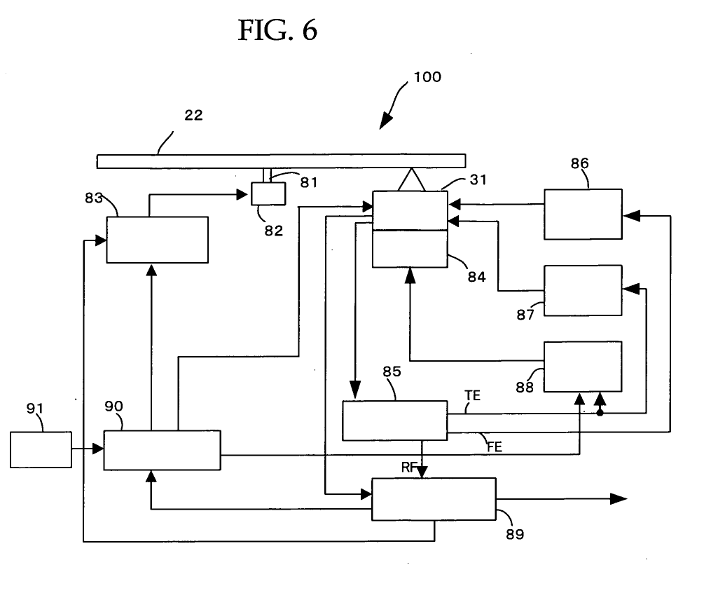

The hologram recording and reproducing apparatus applied to the hologram recording method and the reproducing method will be explained with reference to FIG. 6.

FIG. 6 is an exemplary block flowchart showing the whole mechanism of the hologram recording and reproducing apparatus of the second embodiment. The hologram recording and reproducing apparatus contains both of the hologram recording apparatus and the hologram reproducing apparatus.

This hologram recording and reproducing apparatus 100 is equipped with spindle 81 on which the hologram recording medium 22 is deposed, spindle motor 82 which rotates the spindle 81, and spindle servo circuit 83 which controls the spindle motor 82 so as to maintain the hologram recording medium 22 at a predetermined rotation number.

The hologram recording and reproducing apparatus 100 is also equipped with pickup 31 which irradiates the informing light and the reference light onto the hologram recording medium 22 so as to record information, and irradiates the reproducing reference light onto the hologram recording medium 22 so as to detect the diffracted light to thereby reproduce the information recorded at the hologram recording medium 22, and driving unit 84 which enables the pickup 31 to move in the radius direction of hologram recording medium 22.

The hologram recording and reproducing apparatus 100 is equipped with detecting circuit 85 which detects focusing error signal FE, tracking error signal TE, and reproducing signal RF from the output signal of the pickup 31, focusing servo circuit 86 which drives an actuator in the pickup 31 so as to move an objective lens (not shown) to the thickness direction of the hologram recording medium 22 based on the focusing error signal FE detected by the detecting circuit 85 to thereby perform focusing servo, a tracking servo circuit 87 which drives an actuator in the pickup unit 31 so as to move an objective lens to the thickness direction of the hologram recording medium 22 based upon the tracking error signal TE detected by the detecting circuit 85 to thereby perform tracking servo, and sliding servo unit 88 which controls the driving unit 84 based on the tracking error signal TE and an indication from a controller mentioned hereinafter so as to move the pickup 31 to the radius direction of the hologram recording medium 22 to thereby perform sliding servo.

The hologram recording and reproducing apparatus 100 is also equipped with signal processing circuit 89 which decodes output data of the CMOS or CCD array described below in the pickup unit 31, to thereby reproduce the data recorded in the data area of the hologram recording medium 22, and to reproduce the standard clock or to determine the address based on the reproducing signal RF from the detecting circuit 85, controller 90 which controls the whole hologram recording and reproducing apparatus 100, and controlling unit 91 which affords various instructions to the controller 90.

The controller 90 is configured to input the standard clock or address information outputted from the signal processing circuit 89 as well as controlling the pickup unit 31, the spindle servo circuit 83, the sliding servo circuit 88 and the like. The spindle servo circuit 83 is configured to input the standard clock outputted from the signal processing circuit 89. The controller 90 contains CPU (center processing unit), ROM (read only memory), and RAM (random access memory); the CPU realizes the function of the controller 90 by executing programs stored in the ROM on the RAM as a working area.

The apparatus for generating the fixing light emitted from the second light source in the second embodiment may be properly selected depending on the purpose; for example, another light source-control apparatus is provided in addition to the hologram recording and reproducing apparatus 100, and the fixing light is emitted and controlled while reserving the synchronization with the hologram recording and reproducing apparatus 100, alternatively, the second light source is provided within the hologram recording and reproducing apparatus 100, and the informing light, the reference light and the fixing light are controlled together with.

To the hologram recording and reproducing apparatus, utilized in the hologram recording method and the regenerating method in the second embodiment, the hologram recording medium is employed, thus the recording is carried out by the interference stripes of the informing light and the reference light, the fixing exposure is carried out at the optional sites of the hologram recording layer, and sufficient fixing is carried out as required by the other means selected properly, and also the hologram recording medium may be free from affecting the sensitivity of unrecorded portions and be high density and highly effective in the diffraction.

Hologram Recording Layer

The hologram recording layer may be formed by hardening the composition of hologram recording media according to the present invention.

Filter Layer

The filter layer may perform to prevent diffuse reflection of the informing light and the reference light from the reflective film of the hologram recording medium and to prevent noise generation without the sift of selective reflection wavelength even if the incident angle being altered; therefore, the lamination of the filter layer with the hologram recording medium may achieve optical recording with excellently high resolution and diffraction efficiency.

Preferably, the filter layer performs to transmit the first light and reflect the second light different from the first light; preferably, the wavelength of the first light is 350 nm to 600 nm and the wavelength of the second light is 600 nm to 900 nm. In this connection, the construction of the hologram recording media is preferably such that the hologram recording layer, filter layer and servo pit pattern are laminated in this order from the optical system side.

In addition, the filter layer represents the light transmissivity of 50% or more for 655 nm at the incident angle of ±40°, preferably 80% or more, and the light reflectivity of 30% or more at 532 nm, preferably 40% or more.

The filter layer may be properly selected depending on the purpose; for example, the filter layer may be formed of a laminated body containing a dielectric vapor deposition layer, a cholesteric layer of mono layer or two or more layers, and other layers properly selected as required. The filter layer may also contain a color material-containing layer, for which JP-A No. 2004-352084 is incorporated for reference.

The filter layer may be laminated directly to the support by way of coating etc. along with the hologram recording layer; alternatively, a filter for hologram recording media is prepared by laminating on a base material such as films, then the filter for hologram recording media may be laminated on the support.

Dielectric Vapor Deposition Layer

The dielectric vapor deposition layer is formed from a laminate of plural dielectric thin layers having different refractive indices each other. For the dielectric vapor deposition layer to serve as a wavelength-selective reflection film, a laminate is preferably that contains alternating dielectric thin layers with higher and lower refractive indices; in this connection, three or more different dielectric thin layers may be laminated. When the color material-containing layer is disposed, it is disposed under the dielectric vapor deposition layer.

The number of the laminated layers is preferably 2 to 20, more preferably 2 to 12, still further preferably 4 to 10, and most preferably 6 to 8. When the number of the laminated layers is greater than 20, it results in productivity degradation because of multilayer vapor deposition, and the object and effect of the present invention may hardly be achieved.

The order for laminating the dielectric thin layers may be properly selected depending on the purpose. For example, a dielectric thin layer with lower refractive indices is deposited first in a case where the adjacent dielectric thin layer has a higher refractive index; on the other hand, a dielectric thin layer with a higher refractive index is deposited first in a case where the adjacent dielectric thin layer has a lower refractive index. The threshold of refractive index for determining whether a dielectric thin layer has a high or low refractive index is preferably defined as 1.8. This determination is made on an arbitrary basis; that is, among higher refractive-index materials, there may exist materials with relatively higher or lower refractive indices, and these materials may exist alternatively.

The materials for the dielectric thin layer with higher refractive indices may be properly selected depending on the purpose without limitation; examples thereof include Sb₂O₃, Sb₂S₃, Bi₂O₃, CeO₂, CeF₃, HfO₂, La₂O₃, Nd₂O₃, Pr₆O₁₁, Sc₂O₃, SiO, Ta₂O₅, TiO₂, TlCl, Y₂O₃, ZnSe, ZnS and ZrO₂. Among these, Bi₂O₃, CeO₂, CeF₃, HfO2, SiO, Ta₂O₅, TiO₂, Y₂O₃, ZnSe, ZnS and ZrO₂ are preferable, and SiO, Ta₂O₅, TiO₂, Y₂O₃, ZnSe, ZnS and ZrO₂ are more preferable.

The material for the dielectric thin layer with lower refractive indices may be properly selected depending on the purpose without limitation; examples thereof include Al₂O₃, BiF₃, CaF₂, LaF₃, PbCl₂, PbF₂, LiF, MgF₂, MgO, NdF₃, SiO₂, Si₂O₃, NaF, ThO₂ and ThF₄. Among these, Al₂O₃, BiF₃, CaF₂, MgF₂, MgO, SiO₂ and Si₂O₃ are preferable, and Al₂O₃, CaF₂, MgF₂, MgO, SiO₂ and Si₂O₃ are more preferable.

The atomic ratio in the material for the dielectric thin layer may also be properly selected depending on the purpose; the atomic ratio may be adjusted by changing the gas concentration of atmosphere upon deposition of dielectric thin layers.

The method for producing the dielectric thin layers may be properly selected depending on the purpose; examples of the method include vacuum vapor deposition processes such as ion plating and ion beam, physical vapor deposition (PVD) such as sputtering, and chemical vapor deposition (CVD). Among these methods, vacuum vapor deposition and sputtering are preferable, and the sputtering is most preferable.

As for the sputtering, DC sputtering is preferable because it offers high deposition rate. Preferably, highly conductive material is used when DC sputtering is employed.

Examples of the method for depositing multiple dielectric thin layers by sputtering include single-chamber method, where multiple dielectric thin layers are alternately or sequentially deposited using a single chamber, and multi-chamber method, where multiple dielectric thin layers are sequentially deposited using multiple chambers. In view of the productivity and to prevent contamination among materials, the multi-chamber method is most preferable.

The thickness of the dichroic mirror layer is preferably λ/16 to λ, more preferably λ/8 to 3λ/4, most preferably λ/6 to 3λ/8 in terms of optical wavelength order.

Cholesteric Liquid Crystal Layer

The cholesteric liquid crystal layer comprises at least a cholesterol derivative or a nematic liquid crystal compound and a chiral compound, and a polymerizable monomer and other components as required. The cholesteric liquid crystal layer may be of a mono-layer or plural-layer cholesteric liquid crystal layer.

Preferably, the cholesteric liquid crystal layer displays a circularly polarizing function. The cholesteric liquid crystal layer selectively reflects light components, circularly polarized in the direction to which the liquid crystal helix rotates (i.e., to the right or left), which have a wavelength equal to the pitch of the liquid crystal helix. The cholesteric liquid crystal layer utilizes the selective-reflection characteristics to separate a particular circularly polarized component of a particular wavelength from natural light of different wavelengths, and reflects the other light components.

The filter layer for hologram recording media preferably has an optical reflectivity of 40% or more for a wavelength range of λ₀ to λ₀/cos 40° (where λ₀ represents the wavelength of irradiation light) incident at an angle of ±20° (measured from the normal of the surface of the recording layer). Most preferably, the filter layer for hologram recording media has an optical reflectivity of 40% or more for a wavelength range of λ₀ to λ₀/cos 40° (where λ₀ represents the wavelength of irradiation light) incident at an angle of ±40° (measured from the normal of the surface of the recording layer). When the optical reflectivity is 40% or more for a wavelength range of λ₀ to λ₀/cos 20°, especially λ₀ to λ₀/cos 40° (where λ₀ represents the wavelength of irradiation light), the angle dependency to reflect the irradiation light may be eliminated and thus conventional optical lens systems for usual hologram recording media may be employed. For the purpose, it is preferred that the cholesteric liquid crystal layer represents a wider wavelength width of the selective reflection region.

Specifically, liquid crystals having larger (ne−no) are preferable since the wavelength width Δλ of the selective reflection region may be expressed by the Equation (1) below.
Δλ=2λ(ne−no)/(ne+no): Equation (1)

in which “no” represents the refractive index of the nematic liquid crystal molecules for normal light, contained in the cholesteric liquid crystal layer, “ne” represents the refractive index of the nematic liquid crystal molecules for abnormal light, and λ represents the central wavelength of light selectively reflected.

It is also preferred that a photoreactive chiral compound, having a photosensitive property and capable of significantly changing the spiral pitch of liquid crystal through the action of light, is employed as the chiral as described in JP-A No. 2006-162814, and a filter for hologram recording media is employed of which the spiral pitch alters successively in the thickness direction of the liquid crystal layer by adjusting the content of the photoreactive chiral compound and UV irradiation time.

In the case of plural layers of cholesteric liquid crystal layers, it is preferred that cholesteric liquid crystal layers are laminated of which the central wavelengths of the selective reflectivity are different each other and of which the helical rotation directions are the same each other.

The cholesteric liquid crystal layers may be properly selected depending on the purpose as long as satisfying the properties described above; the cholesteric liquid crystal layers contain a nematic liquid crystal compound and a chiral compound, and further contain polymerizing monomers and other components as required.

Nematic Liquid Crystal Compound

The nematic liquid crystal compounds feature that their liquid crystal phase solidifies under their liquid crystal transition temperatures, and may be properly selected from liquid crystal compounds, high-molecular liquid crystal compounds and polymerizable liquid crystal compounds, all of which have refractive index anisotropy Δn of 0.10 to 0.40. For example, molecules of such nematic liquid crystal compounds in a liquid crystal state may be aligned on a substrate treated for the alignment such as rubbing, followed by cooling to immobilize the molecules for an available solid phase.

Among the exemplified compounds, the nematic liquid crystal compounds are preferably those having at least a polymerizable group per molecule from the view point of assuring sufficient curing ability. Among these, ultraviolet (UV) polymerizable liquid crystal compounds are preferable. Such UV polymerizable liquid crystal compounds are commercially available; examples thereof include PALIOCOLOR LC242 (product name, by BASF Corp.), E7 (product name, by Merck Ltd.), LC-Silicon-CC3767 (product name, by Wacker-Chemie GmbH), and L35, L42, L55, L59, L63, L79 and L83 (product name, by Takasago International Corp.).

The content of the nematic liquid crystal compound is preferably 30% by mass to 99% by mass, more preferably 50% by mass to 99% by mass based on the total solid mass of each of the cholesteric liquid crystal layers. When the content of the nematic liquid crystal compound is less than 30% by mass, the alignment of nematic liquid crystal molecules may be insufficient.

Chiral Compound

The chiral compound may be properly selected from conventional ones depending on the purpose in the case of plural layers of cholesteric liquid crystal layers in particular; examples thereof include isomannide compounds, catechine compounds, isosorbide compounds, fenchone compounds and carvone compounds in view of the hues of the liquid crystal compounds and for enhanced color purity. These compounds may be used alone or in combination of two or more.

In addition, commercially available chiral compounds may be available; examples thereof include S101, R811 and CB15 (product name, by Merck Ltd.); and PALIOCOLOR LC756 (product name, by BASF Corp.).

The content of the chiral compound in the respective liquid crystal layers is preferably no more than 30% by mass based on the total solid mass of each of the cholesteric liquid crystal layers, more preferably no more than 20% by mass. When the content of the nematic liquid crystal compound is more than 30% by mass, the alignment of cholesteric liquid crystal layers may be insufficient.

Polymerizable Monomer

Polymerizable monomers may be additionally included to the cholesteric liquid crystal layer in order to, for example, increase the curing level such as film strength. Additional use of polymerizable monomers may increase the strength of the cholesteric liquid crystal layer, in a way that twisting degrees of liquid crystals are altered through which a light propagates (e.g., after the distribution of selection wavelength being created) and the helical structure (i.e., selective reflection capability) is fixed. When the liquid crystal compound bears polymerizable groups in a molecule, such additional polymerizable monomers are not necessarily required.

The polymerizable monomers may be properly selected from conventional ones depending on the purpose; examples thereof include monomers with ethylenically unsaturated bonds, more specifically, multifunctional monomers such as pentaerythritoltetraacrylate and dipentaerythritolhexaacrylate. These may be used alone or in combination of two or more.

The content of the polymerizable monomers is preferably no more than 50% by mass, more preferably 1% by mass to 20% by mass based on the total solid mass of the cholesteric liquid crystal layer. When the content the polymerizable monomers is more than 50% by mass, the alignment may be inhibited in the cholesteric liquid crystal layer.

Other Components

The other components may be properly selected depending on the purpose; examples thereof include photopolymerization initiators, sensitizers, binder resins, polymerization inhibitors, solvents, surfactants, thickeners, dyes, pigments, ultraviolet absorbers and gelling agents.

The photopolymerization initiators may be properly selected from conventional ones without limitation; examples thereof include p-methoxyphenyl-2,4-bis(trichloromethyl)-s-triazine, 2-(p-buthoxystyryl)-5-trichloromethyl-1,3,4-oxadiazole, 9-phenylacridine, 9,10-dimethylbenzphenazine, benzophenone/Michler's ketone, hexaarylbiimidazole/mercaptobenzoimidazole, benzyldimethylketal and thioxanthone/amine. These may be used alone or in combination of two or more.

The photopolymerization initiators may be commercially available; examples thereof include IRGACURE 907, IRGACURE 369, IRGACURE 784 and IRGACURE 814 (product name, by Ciba Specialty Chemicals); and Lucirin TPO (product name, by BASF Corp.).

The content of the photopolymerization initiator is preferably 0.1% by mass to 20% by mass, more preferably 0.5% by mass to 5% by mass based on the total solid mass of the cholesteric liquid crystal layer. When the content of the photopolymerization initiator is less than 0.1% by mass, it may take long time for the polymerization because of reduced curing efficiency upon irradiation with light. When the content of the photopolymerization initiator is more than 20% by mass, it may result in poor optical transmittance over the spectrum from ultraviolet to visible light.

The sensitizer is added as required in order to increase the cure level in the cholesteric liquid crystal layer. The sensitizer may be properly selected from conventional ones depending on the purpose; examples thereof include diethylthioxanthone and isopropylthioxanthone. The content of the sensitizer is preferably 0.001% by mass to 1% by mass based on the total solid mass of the cholesteric liquid crystal layer.

The binder resin may be properly selected from conventional ones depending on the purpose without limitation; examples thereof include polyvinyl alcohols; polystyrene compounds such as polystyrene and poly-α-methylstyrene; cellulose resins such as methylcellulose, ethylcellulose and acetylcellulose; acid cellulose derivatives having a carboxylic group on their side chains; acetal resins such as polyvinyl formal and polyvinyl butyral; methacrylic acid copolymers; acrylic acid copolymers; itaconic acid copolymers; crotonic acid copolymers; malleic acid copolymers; partially-esterified malleic acid copolymers; homopolymers of acrylic acid alkylesters or homopolymers of methacrylic acid alkyl esters; and polymers having a hydroxyl group. These binder resins may be used alone or in combination of two or more.

Examples of. alkyl groups in the homopolymers of acrylic acid alkylesters. or homopolymers of methacrylic acid alkyl esters include methyl group, ethyl group, n-propyl group, n-butyl group, isobutyl group, n-hexyl group, cyclohexyl group and 2-ethylhexyl group.

Examples of the polymers having hydroxyl group include benzyl(meth)acrylate/(methacrylic acid homopolymers)acrylic acid copolymers, and multicomponent copolymers of benzyl(meth)acrylate/(meth)acrylic acid/other monomers.

The content of the binder resin is preferably no more than 80% by mass based on the total solid mass of the cholesteric liquid crystal layer, more preferably no more than 50% by mass. When the content the polymerizable monomers is more than 80% by mass, the alignment may be insufficient in the cholesteric liquid crystal layer.

The polymerization inhibitor may be properly selected depending on the purpose without limitation; examples thereof include hydroquinones, hydroquinone monoethylethers, phenothiazines, benzoquinones and derivatives thereof. The content of the polymerization inhibitor is preferably 10% by mass or less, more preferably 0.01% by mass (100 ppm) to 1% by mass based on the total solid content of the polymerizable monomer.

The solvent may be properly selected from conventional ones depending on the purpose; examples thereof include alkoxypropionic acid esters such as 3-methoxypropionic acid methylester, 3-methoxypropionic acid ethylester, 3-methoxypropionic acid propylester, 3-ethoxypropionic acid methylester, 3-ethoxypropionic acid ethylester and 3-ethoxypropionic acid propylester; alkoxy alcohol esters such as 2-methoxypropylacetate, 2-ethoxypropylacetate and 3-methoxybutylacetate; lactic acid esters such as methyl lactate and ethyl lactate; ketones such as methyl ethyl ketone, cyclohexanone and methylcyclohexanone; γ-butyrolactone, N-methylpyrrolidone, dimethylsulfoxide; chloroform and tetrahydrofuran. These solvents may be used alone or in combination.

The cholesteric liquid crystal layer may be formed in the following procedure: for example, a coating liquid for cholesteric liquid crystal layer prepared by use of solvents described above is applied on the base material, or respective coating liquids are applied in the case of a multilayered cholesteric liquid crystal layer, thereafter, the coating liquid is dried and cured by irradiating it with UV rays.

For mass production, the cholesteric liquid crystal layer can be formed in the following procedure: the base material is previously wound in a roll shape, then the coating liquid is applied on the base material using a long, continuous coater such as bar coater, die coater, blade coater and curtain coater.

Examples of the coating method include spin coating method, casting method, roll coating method, flow coating method, printing method, dip coating method, casting deposition method, bar coating method and gravure printing method.

The UV irradiation condition is not particularly limited and can be appropriately determined depending on the purpose; the wavelength of UV rays is preferably 160 nm to 380 nm, more preferably 250 run to 380 nm; irradiation time is preferably 0.1 second to 600 seconds, more preferably 0.3 second to 300 seconds. By adjusting the UV irradiation condition, it is possible to change the helical pitch of the cholesteric liquid crystal layer continuously in the thickness direction of the liquid crystal layer.

It is also possible to add an ultraviolet absorber to the cholesteric liquid crystal layer in order to adjust the UV irradiation condition. The ultraviolet absorber is not particularly limited and can be appropriately selected depending on the intended purpose; suitable examples thereof include benzophenone ultraviolet absorbers, benzotriazole ultraviolet absorbers, salicylic acid ultraviolet absorbers, cyanoacrylate ultraviolet absorbers and oxalic acid anilide ultraviolet absorbers. Specific examples of these ultraviolet absorbers are disclosed in JP-A Nos. 47-10537, 58-111942, 58-212844, 59-19945, 5946646, 59-109055 and 63-53544; Japanese Examined Patent Publication (JP-B) Nos. 36-10466, 42-26187, 48-30492, 48-31255, 4841572, 48-54965 and 50-10726; and U.S. Pat. Nos. 2,719,086, 3,707,375, 3,754,919 and 4,220,711.

In the case of the multilayered cholesteric liquid crystal layer, the thickness of each cholesteric liquid crystal layer is preferably 1 μm to 10 μm, and is more preferably 2 μm to 7 μm. When the thickness of the cholesteric liquid crystal layer is less than 1 μm, it results in poor selective reflectivity. When the thickness of the cholesteric liquid crystal layer is more than 10 μm, uniformly aligned liquid crystal molecules may orient in random directions in the cholesteric liquid crystal layer.

The total thickness of the cholesteric liquid crystal layer in a multilayered cholesteric liquid crystal layer (or the thickness of a single-layered liquid crystal layer) is preferably 1 μm to 30 μm, and is more preferably 3 μm to 10 μm.

Method of Producing Filter for Hologram Recording Media Containing Cholesteric Layer

The method of producing the filter for hologram recording media may be properly selected depending on the purpose.

The filter for hologram recording media may be properly selected depending on the purpose; preferably, the filter is processed into disc-shape by punching through and arranged on the second substrate of the hologram recording medium. When applied as the filter layer for hologram recording media, it can be directly arranged on the second substrate without a base material.

Base Material

The base material may be properly selected depending on the purpose; for example, the same material as for the support in the first embodiment may be also used.

The base material may be properly prepared or commercially available. The thickness of the base material may be properly selected depending on the purpose; preferably the thickness is 10 μm to 500 μm, more preferably 50 μm to 300 μm. When the thickness of the base material is less than 10 μm, the adhesiveness may be lower due to deflection of the substrate, and when over 500 μm, the focus sites of the informing light and the reference light are required to shift considerably, which leading to larger size of the optical system.

In order to laminate to form the cholesteric liquid crystal layer, conventional adhesives or tackiness agents may be properly selected or combined as required.

The tackiness agent may be properly selected depending on the purpose; examples thereof include rubber agents, acrylic agents, silicone agents, urethane agents, vinylalkyl ether agents, polyvinylalcohol agents, polyvinylpyrrolidone agents, polyacrylamide agents and cellulose agents.

The thickness of the adhesives or tackiness agents may be properly selected depending on the purpose. In the case of adhesives, the thickness is preferably 0.1 μm to 10 μm, more preferably 0.1 μm to 5 μm in light of the optical characteristics and slimness. In the case of tackiness agents, the thickness is preferably 1 μm to 50 μm, more preferably 2 μm to 30 μm.

In addition, the filter layer can be formed directly on the substrate on occasion.

Hologram Recording Medium with Reflective Film, First and Second Gap Layers

The hologram recording medium is equipped with a first substrate, a second substrate, a recording layer disposed between the first substrate and the second substrate, and a filter layer disposed between the second substrate and the recording layer. The hologram recording medium may further include a reflective film, a first gap layer and a second gap layer, and other layers as required.

Substrate

The substrate may be properly selected depending on the purpose as for the shape, configuration, size etc.; the shape may be disc-like, card-like etc.; the material is required for the mechanical strength in terms of the hologram recording media. In the case that the light for recording or reproducing is directed through the substrate, it is necessary that the substrate is sufficiently transparent at the wavelength region of the employed light.

The material of the substrate is usually selected from glasses, ceramics, resins etc.; preferably, resins are employed in particular from the view point of formability and cost.

Examples of the resins include polycarbonate resins, acrylic resins, epoxy resins, polystyrene resins, acrylonitrile-styrene copolymers, polyethylene resins, polypropylene resins, silicone resins, fluorine resins, ABS resins and urethane resins. Among these, polycarbonate resins and acrylic resins are most preferable in view of their formability, optical characteristics and costs. The substrate may be properly prepared or commercially available.

Plural address-servo areas, i.e. addressing areas linearly extending in the radial direction of the substrate, are provided on the substrate at a given angle to one another, and each sector-form area between adjacent address-servo areas serves as a data area. In the address-servo areas, information for a focus servo operation and a tracking servo operation by means of a sampled servo system and address information are previously recorded (or pre-formatted) in the form of emboss pits (servo pits). The focus servo operation can be performed using a reflective surface of the reflective film. For example, wobble pits are used as the information for tracking servo. The servo pit pattern is not necessarily required in the case that the hologram recording medium is card-like shape.

The thickness of the substrate may be properly selected depending on the purpose; the thickness is preferably 0.1 mm to 5 mm, more preferably 0.3 mm to 2 mm. When the thickness of the substrate is less than 0.1 mm, the optical disc may be deformed during its storage; and when the thickness is more than 5 mm, the weight of the optical disc may be as heavy as excessively loading on the drive motor.

Reflective Film

The reflective film is formed on the surface of the servo pit pattern of the substrate. As for the material of the reflective film, such material is preferable that provides the recording light and the reference light with high reflectivity. When the wavelength of light is 400 nm to 780 nm, Al, Al alloys, Ag, Ag alloys and the like are preferably used. When the wavelength of light is 650 nm or more, Al, Al alloys, Ag. Ag alloys, Au, Cu alloys, TiN and the like are preferably used.

By use of DVD (digital video disc), for example, as the hologram recording medium capable of reflecting the light and also recording and erasing information, such directory information can be recorded and erased without adversely affecting holograms as those indicative of the locations where information being recorded, the time when the information being recorded, and the locations where errors being occurred and exchanged.

The process for forming the reflective film may be properly selected depending on the purpose; examples thereof include various types of vapor deposition, such as a vacuum vapor deposition, sputtering, plasma CVD, photo CVD, ion plating, and electron beam vapor deposition. Among these, sputtering is most preferable in view of mass productivity, film quality, and the like. The thickness of the reflective film is preferably 50 nm or more, more preferably 100 nm or more, in order to secure sufficient reflectivity.

First Gap Layer

The first gap layer is provided between the filter layer and the reflective film as required for smoothing the surface of the substrate. Moreover, the first gap layer is effective to adjust the size of the hologram formed in the recording layer. Specifically, the gap layer between the recording layer and the servo pit pattern may be effective, since the recording layer requires the interference region of some larger size between the recording reference light and the informing light.

The first gap layer can be formed by, for example, applying UV curable resin etc. on the servo pit pattern by spin coating etc. and by curing the resin. In addition, when a filter layer is formed on a transparent base material, the transparent base material also serves as the first gap layer. The thickness of the first gap layer may be properly selected depending on the purpose; the thickness is preferably 1 μm to 200 μm.

Second Gap Layer

The second gap layer may be provided between the hologram recording layer and the filter layer as required.

The material for the second gap layer may be properly selected depending on the purpose; examples thereof include transparent resin films such as triacetylcellulose (TAC), polycarbonate (PC), polyethylene terephthalate (PET), polystyrene (PS), polysulfone (PSF), polyvinylalcohol (PVA) and methyl polymethacrylate (PMMA); norbornene resin films such as ARTON (product name, by JSR Corp.), ZEONOA (product, by Nippon Zeon). Among these, those with higher isotropy are preferable, and TAC, PC, ARTON and ZEONOA are most preferable.

The thickness of the second gap layer may be properly selected depending on the purpose; the thickness is preferably 1 μm to 200 μm.

Hereinafter, embodiments of the hologram recording medium of the present invention, which includes the reflective film and the first and second gap layers, will be described in detail with reference to the drawings.

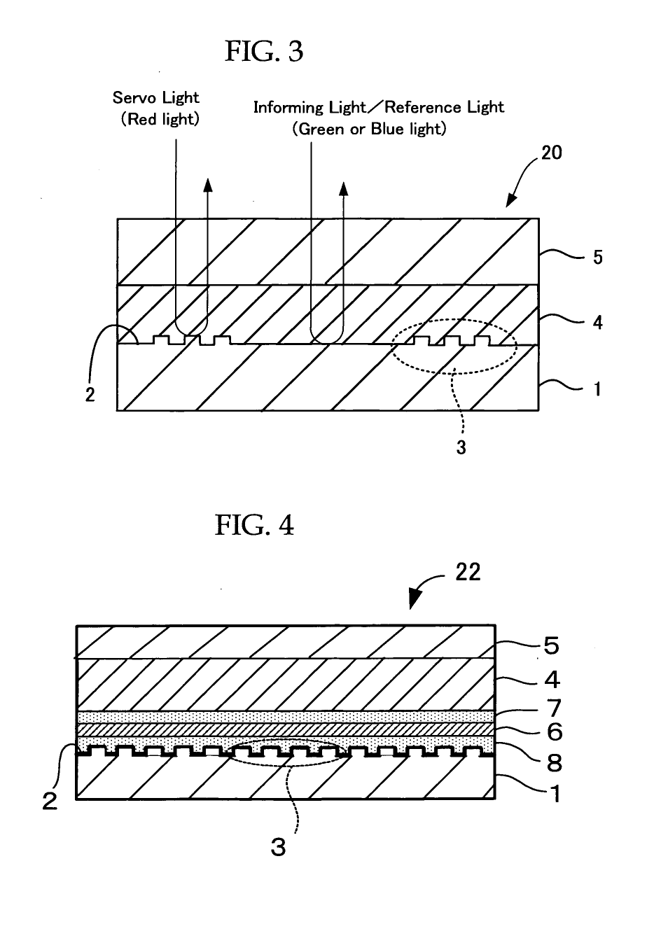

FIG. 4 is a schematic cross-sectional view showing the structure of the first embodiment of the hologram recording medium in the present invention. In the hologram recording medium 22 according to the first embodiment, servo pit pattern 3 is formed on the second substrate 1 made of a polycarbonate resin or glass, and the servo pit pattern 3 is coated with Al, Au, Pt or the like to form reflective film 2. Although the servo pit pattern 3 is formed on the entire surface of the second substrate 1 in FIG. 4, it may be formed periodically as the hologram recording medium 20 shown in FIG. 3. The height of the servo pit pattern 3 is usually 1750 angstroms (175 nm), which being significantly smaller than the other layers including the substrate.

The first gap layer 8 is formed by applying UV curable resin or the like on the reflective film 2 of the second substrate 1 by spin coating or the like. The first gap layer 8 is effective for protecting the reflective film 2 and for adjusting the size of holograms created in hologram recording layer 4. Specifically, the interference region between the recording reference light and the informing light requires a level of size in the hologram recording layer 4, a clearance is effectively provided between the hologram recording layer 4 and the servo pit pattern 3.

The filter layer 6 is provided on the first gap layer 8, the second gap layer 7 is provided between the filter layer 6 and the first substrate 5 (polycarbonate resin or glass substrate), and the hologram recording layer 4 is sandwiched to thereby constitute the hologram recording medium 22.

In FIG. 4, the filter layer 6 transmits only red light and blocks other color lights. Since the informing light, recording light and reproducing reference light are of green or blue, they do not pass through the filter layer 6 instead turn into a return light to emit from the entrance/exit surface A without reaching the reflective film 2.

The hologram recording medium 22 of the first embodiment may be of disc shape or card shape as shown in FIG. 2. The servo pit pattern is unnecessary in the case of card shape. In the hologram recording medium 22, the second substrate 1 is 0.6 mm thick, the first gap layer 8 is 100 μm thick, the filter layer 6 is 2 μm to 3 μm thick, the hologram recording layer 4 is 0.6 mm thick, and the first substrate 5 is 0.6 mm thick, leading to the total thickness of about 1.9 mm.

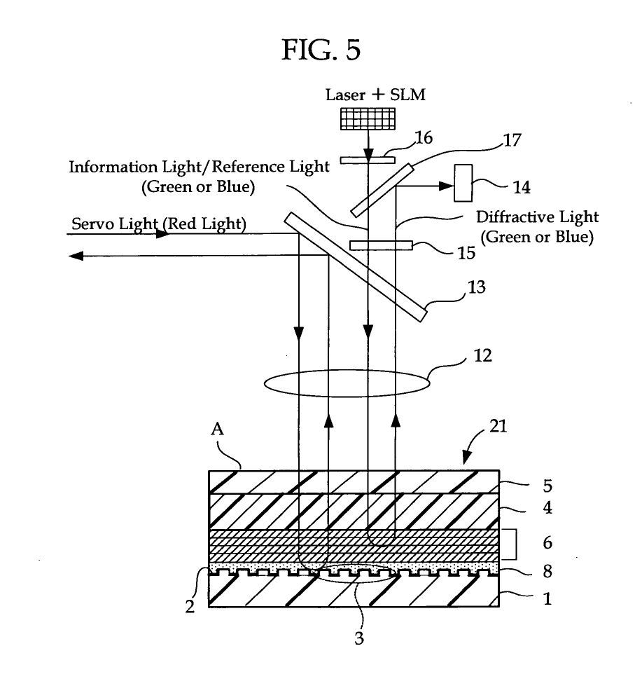

The optical operations around the hologram recording medium 22 will be explained with reference to FIG. 5 in the following. Initially, red light emitted from the servo laser source is reflected by dichroic mirror 13 by almost 100%, and passes through objective lens 12. The servo light 10 is applied onto the hologram recording medium 22 in such a way that it focuses on the reflective film 2. More specifically, the dichroic mirror 13 is configured to transmit only green or blue light but reflect almost 100% of red light. The servo light incident from the light entrance/exit surface A of the hologram recording medium 22 passes through the first substrate 5, hologram recording layer 4, second gap layer 7, filter layer 6 and first gap layer 8, then is reflected by the reflective film 2, and passes again through the first gap layer 8, filter layer 6, second gap layer 7, recording layer 4 and first substrate 5 to emit from the light entrance/exit surface A. The emitted return light passes through the objective lens 12 and is reflected by the dichroic mirror 13 by almost 100%, and then a servo information detector (not shown) detects servo information. The detected servo information is used for the focus servo operation, tracking servo operation, slide servo operation and the like. The hologram material constituting the hologram recording layer 4 is designed so as not to be sensitive to red light, therefore, even when the servo light passes through the hologram recording layer 4 or reflects diffusively at the reflective film 2, the recording layer 4 is not adversely affected. In addition, the return servo light reflected by the reflective film 2 is reflected almost 100% by the dichroic mirror 13, accordingly, the servo light is non-detectable by CMOS sensor or CCD 14 used for the detection of reconstructed images, thus providing the diffracted light with no noise.

Both of the informing light and the recording reference light emitted from the recording/reproducing laser source pass through the polarizing plate 16 to form a linear polarization then to form a circular polarization after passing through the half mirror 17 and the quarter wave plate 15. The circular polarization then passes through the dichroic mirror 13, and illuminates the hologram recording medium 22 by action of the objective lens 12 in a manner that the informing light and the reference light create an interference pattern in the hologram recording layer 4. The informing light and reference light enter from the light entrance/exit surface A and interact with each other in the recording layer 4 to form and record an interference pattern. Thereafter, the informing light and reference light enters into the recording layer 4 and the filter layer 6, and then, are reflected to turn into a return light before reaching the bottom of the filter layer 6. That is, the informing light and recording reference light do not reach the reflective film 2. This is because the filter layer 6 transmits exclusively red light. Alternatively, provided that the intensity of light leaking and transmitting from the filter can be suppressed to no more than 20% of the incident light, even when the leaking light reaches the bottom face and turns into a return light, the intensity of light intermixed with the diffracted light comes to no more than 4% (20%×20%) since the it being reflected at the filter layer again, thus no problem occurs substantially.

Method for Producing Hologram Recording Medium

The method for producing the hologram recording medium according to the present invention may be properly selected depending on the purpose; the method comprises at least a step of forming a hologram recording layer, a step of forming a filter layer in the case of having the filter layer, and other steps such as a step of forming a reflective film as required. The step of forming the reflective film is described above.

Step of Forming Hologram Recording Layer

In the step of forming a hologram recording layer, the composition of hologram recording media according to the present invention is heated to above the gelling temperature at which the organic gelling agent gels, then disposed between the first and the second substrates to form a hologram recording layer. The process for disposing the hologram recording layer between the first and the second substrates is described above in relation to the hologram recording layer.

Step of Forming Filter Layer

In the step of forming a filter layer, the filter for hologram recording media is processes into a shape of a hologram recording medium, the resulting filter is laminated on the second substrate to form a filter layer. The method for producing the inventive filter for hologram recording media is described above.

The shape of the hologram recording medium may be, for example, disc-like or card-like. The method for processing the filter into the shape of the hologram recording medium may be properly selected depending on the purpose; such processes may be employed as a cutting process with a press cutter and stamping process with a stamping cutter. In carrying out the lamination, for example, the filter is laminated to the substrate using an adhesive or tackiness agent in a manner of no air being entrapped therebetween.

The adhesive may be properly selected depending on the purpose; examples thereof include UV curable adhesives, emulsion adhesives, one-component curable adhesives and two-component curable adhesives. These conventional adhesives may also be employed in appropriate combination of two or more.

The tackiness agent may be properly selected depending on the purpose; examples thereof include rubber agents, acrylic agents, silicone agents, urethane agents, vinylalkyl ether agents, polyvinyl alcohol agents, polyvinyl pyrrolidone agents, polyacrylamide agents and cellulose agents.

The thickness of the adhesive or tackiness agent may be properly selected depending on the purpose; from the viewpoint of optical properties and demands for thinning, the thickness of the adhesive is preferably 0.1 μm to 10 μm, more preferably 0.1 μm to 5 μm and the thickness of the tackiness agent is preferably 0.1 μm to 50 μm, more preferably 2 μm to 30 μm.

It is possible to directly form the filter layer on the substrate depending on the circumstances. For example, a coating liquid for color material-containing layer is applied onto the substrate to form a color material-containing layer, and a dielectric vapor deposition film is formed on the color material-containing layer by a sputtering process.

Hologram Reproducing Method

The inventive method for reproducing hologram recording media may be properly selected depending on the purpose; for example, the method comprises irradiating the same light from the same direction as the reference light at the recording onto the hologram recording medium which being recorded by the hologram recording method according to the present invention. Specifically, the light is irradiated to the interference image formed in the hologram recording layer of the hologram recording medium, thereby a diffracted light is generated with recorded information corresponding to the interference image, and the reproduction may be carried out by receiving the diffracted light.

### EXAMPLES

The present invention will be explained with reference to Examples, which are given for no more than illustration of the invention rather than for limiting its intended scope. Through this disclosure, all of percentage (%) are expressed by mass unless otherwise indicated.

### Example 1

Preparation of Composition for Hologram Recording Media

A composition for hologram recording media was prepared by blending the components shown below under nitrogen atmosphere.

| | |
|---|---|
| Butylcarbamate(2-methoxy-1-methylethyl)ester | 45% |
| Di(urethane acrylate)oligomer ¹⁾ | 50.21% |
| N,N′-didodecanoyl-trans-(1R,2R)-1,2-cyclohexanediamine ²⁾ | 1.0% |
| 2,4,6-tribromophenylacrylate | 3.1% |
| Photopolymerization initiator ³⁾ | 0.69% |

¹⁾ ALU-351, by Echo Resins Inc.
²⁾ organic gelling agent
³⁾ IRGACURE 784, by Ciba Specialty Chemicals

The aforementioned components other than the N,N′-didodecanoyl-trans-(1R,2R)-1,2-cyclohexanediamine were blended and heated to 70° C., then N,N′-didodecanoyl-trans-(1R,2R)-1,2-cyclohexanediamine was added to the mixture to prepare Composition 1 for hologram recording media.

Preparation of Hologram Recording Medium

One surface of a glass sheet having a thickness of 0.5 mm was subjected to antireflection treatment so as to give a reflectivity of 0.1% with respect to a normal incident having a wavelength of 532 nm, to thereby obtain a first substrate. One surface of another glass sheet having a thickness of 0.5 mm was subjected to aluminum deposition so as to give a reflectivity of 90% with respect to a normal incident having a wavelength of 532 nm, to thereby obtain a second substrate.

Then, a spacer of transparent polyethylene terephthalate sheet having a thickness of 500 μm was disposed on the surface of the first substrate which being not subjected the antireflection treatment, and heated to 70° C., then the composition of the hologram recording media was applied on the first substrate. Then the side of the second substrate, where the aluminum being deposited, was contacted to the side of the composition of the hologram recording media on the first substrate so as to trap no air therebetween, thereby the first substrate and the second substrate were laminated along with the spacer interposed therebetween. Finally, the laminate was allowed to cool to room temperature, resulting in a hologram recording medium with a hologram recording layer. The period for gelling was 20 minutes and the gelling temperature was 50° C.

Recording and Evaluation of Hologram Recording Medium

By means of Collinear hologram recording and reproducing examiner SHOT-1000 (by PULSTEC INDUSTRIAL CO., LTD.), the resulting hologram recording medium was subjected to writing a series of multiplex holograms with a recording spot diameter of 200 μm at the focal point of the hologram recording. The recorded holograms were measured and evaluated in terms of sensitivity (recording energy) and multiplex index.

Measurement of Sensitivity

The irradiation light energy (mJ/cm²) was varied at the recording, and a variation of bit error rate (BER) of the reproduction signal was measured. Generally speaking, as the power of the recording beam is increased, the brightness of the reproduction signal is increased, and the BER of the reproduction signal tends to gradually decrease. In this case, the recording photosensitivity was determined with respect to the minimum irradiation light energy which provided an approximately clear reproduced image (BER<10⁻³). The results are shown in Table 1.

Evaluation of Multiplex Index

As a multiplex index evaluation for the hologram recording medium, a method described in “ISOM'04, Th-J-06, pp. 184-185, October 2004” was applied. In this method, a recording spot was made shifted in a spiral direction to evaluate the multiplex index. Here, the number of the recorded hologram was set at 13×13=169 holograms, and the recording pitch was set at 28.5 μm. The multiplex index was 49 at the final (169th) hologram recording.

As the number of the recorded holograms is increased, the multiplex index is increased; therefore, insufficient multiplicity results in increase of the BER as the recorded number increases. Accordingly, the number of the recording hologram volume at BER>10⁻³ was determined as the multiplex property M of the hologram recording medium. The results are shown in Table 1.

### Example 2

A composition for hologram recording media was prepared in the same manner as Example 1 except that the content of the N,N′-didodecanoyl-trans-(1R,2R)-1,2-cyclohexanediamine as the organic gelling agent was changed into 6.0% by mass in the composition for hologram recording media, the content of the butylcarbamate(2-methoxy-1-methylethyl)ester was changed into 40% by mass, and the heating temperature was changed into 90° C., then the hologram recording medium of Example 2 was prepared and evaluated in terms of sensitivity and multiplex index. The period for gelling was 20 minutes and the gelling temperature was 80° C. The results are shown in Table 1.

### Example 3

A composition for hologram recording media was prepared in the same manner as Example 1 except that 1% by mass of the N,N′-didodecanoyl-trans-(1R,2R)-1,2-cyclohexanediamine as the organic gelling agent in the Composition 1 for hologram recording media was changed into 1.0% by mass of dibenzylidene-D-sorbitol, then the hologram recording medium of Example 3 was prepared and evaluated in terms of sensitivity and multiplex index. The period for gelling was 20 minutes and the gelling temperature was 30° C. The results are shown in Table 1.

### Example 4

Preparation of Composition for Hologram Recording Media

In the similar manner as Example 1, Composition 2 for hologram recording media was prepared by blending the components shown below under nitrogen atmosphere, then the hologram recording medium of Example 4 was prepared and evaluated in terms of sensitivity and multiplex index. The period for gelling was 20 minutes and the gelling temperature was 65° C. The results are shown in Table 1.

| | |
|---|---|
| Tricresyl phosphate | 55% |
| Poly(ethylmethacrylate) ¹⁾ | 40.21% |
| trans-(1R,2R)-1,2-bis(dodecylureido)cyclohexane ²⁾ | 1.0% |
| 2,4,6-tribromophenylacrylate | 3.1% |
| Photopolymerization initiator ³⁾ | 0.69% |

¹⁾ average molecular weight: 3000
²⁾ organic gelling agent
³⁾ IRGACURE 784, by Ciba Specialty Chemicals

### Comparative Example 1

Preparation of Composition for Hologram Recording Media

Composition 3 for hologram recording media was prepared by blending the components shown below under nitrogen atmosphere.

| | |
|---|---|
| Biscyclohexylmethane diisocyanate | 31.5% |
| Polypropyleneoxide triol ¹⁾ | 61.2% |
| Tetramethylene glycol | 2.5% |
| 2,4,6-tribromophenylacrylate | 3.1% |
| Photopolymerization initiator ²⁾ | 0.69% |
| Dibutyltin dilaurate | 1.01% |

¹⁾ average molecular weight: 1000
²⁾ IRGACURE 784, by Ciba Specialty Chemicals

Preparation of Hologram Recording Medium

One surface of a glass sheet having a thickness of 0.5 mm was subjected to antireflection treatment so as to give a reflectivity of 0.1% with respect to a normal incident having a wavelength of 532 nm, to thereby obtain a first substrate. One surface of another glass sheet having a thickness of 0.5 mm was subjected to aluminum deposition so as to give a reflectivity of 90% with respect to a normal incident having a wavelength of 532 nm, to thereby obtain a second substrate.

Then, a spacer of transparent polyethylene terephthalate sheet having a thickness of 500 μm was disposed on the surface of the first substrate which being not subjected the antireflection treatment, then the composition for hologram recording media was applied on the first substrate. Then the side of the second substrate, where the aluminum had been deposited, was contacted to the side of the composition of the hologram recording media on the first substrate so as not to trap any air therebetween, thereby the first substrate and the second substrate were laminated along with the spacer interposed therebetween. Finally, the edges of the laminate was sealed with a moisture-curable adhesive, and allowed to stand for 24 hours at 45° C. to prepare a hologram recording medium, which was evaluated in terms of sensitivity and multiplex index in the same manner as Examples. The results are shown in Table 1.

TABLE 1

| | Recording Sensitivity | |
|---|---|---|
| | (mJ/cm²) | Multiple Index M |
| Ex. 1 | 60 | 100 |
| Ex. 2 | 60 | 80 |
| Ex. 3 | 60 | 90 |
| Ex. 4 | 70 | 100 |
| Com. Ex. 1 | 80 | 70 |

The results as to the compositions for hologram recording media of Examples 1 to 4 shown in Table 1 demonstrate that the compositions employing the organic gelling agents may lead to improvements in recording sensitivity and multiplicity property compared to Comparative Example 1 with no gelling agent. In addition, the compositions for hologram recording media of Examples 1 to 4 may exhibit shorter curing times due to gelling, which may bring about efficient production of hologram recording media.

In accordance with the present invention, various problems in the prior art may be solved, that is, compositions for hologram recording media may be produced that make possible to provide high-quality hologram recording media efficiently with less time-consuming and without being affected by moisture due to employing organic gelling agents, and also volume-type hologram recording media that are adapted to high-density recording due to employing the composition for hologram recording media may be provided, a method for producing the volume-type hologram recording media may be provided that can produce efficiently the hologram recording media with lower cost, and further a hologram-recording method and a hologram-reproducing method may be provided that utilize the hologram recording media respectively.

The compositions for hologram recording media according to the present invention may make possible to form hologram recording layers with shorter time and without moisture affection due to organic gelling agents, thus may be applied to hologram recording media according to the present invention capable of high-density image recording.

The hologram recording media according to the present invention may have higher thicknesses of hologram recording layers and exhibit superior recording sensitivity and multiplicity property, thus may be applied as various hologram recording media capable of high-density image recording.

The hologram recording methods according to the present invention may utilize hologram recording layers with larger thicknesses, and superior recording sensitivity and multiplicity property, thus may be applied as various hologram recording methods capable of high-density image recording.

The hologram reproducing methods according to the present invention may utilize hologram recording layers with larger thicknesses, and superior recording sensitivity and multiplicity property, thus may be applied as various information reproducing methods from various hologram recording media capable of high-density image recording.

What is claimed is:

1. A composition for hologram recording media, comprising:
a polymerizable monomer, a photopolymerization initiator, a non-polymerizable compound, and an organic gelling agent.

2. The composition for hologram recording media according to claim 1, wherein the gelling temperature of the organic gelling agent is 30° C. to 80° C.

3. A hologram recording medium, comprising:
a first substrate, a second substrate, and a hologram recording layer on the second substrate capable of recording information by means of holography,
wherein the hologram recording layer is formed from a composition for hologram recording media comprising a polymerizable monomer, a photopolymerization initiator, a non-polymerizable compound, and an organic gelling agent.

4. The hologram recording medium according to claim 3, wherein the hologram recording layer is formed by heating the composition for hologram recording media at above the gelling temperature of the organic gelling agent to solate the composition, followed by disposing the solated composition between the first substrate and the second substrate.

5. A method for producing a hologram recording medium, equipped with at least a first substrate, a second substrate, and a hologram recording layer on the second substrate capable of recording information by means of holography, comprising:
heating a composition for hologram recording media, comprising a polymerizable monomer, a photopolymerization initiator, a non-polymerizable compound, and an organic gelling agent, at above the gelling temperature of the organic gelling agent, followed by disposing the composition between the first substrate and the second substrate to form a hologram recording layer.

6. A hologram recording method comprising:
irradiating an informing light and a reference light onto a hologram recording medium, and
recording information on a hologram recording layer by means of an interference pattern formed by the interference between the informing light and the reference light,
wherein the hologram recording medium comprises a first substrate, a second substrate, and a hologram recording layer on the second substrate capable of recording information by means of holography, and
the hologram recording layer is formed from a composition for hologram recording media comprising a polymerizable monomer, a photopolymerization initiator, a non-polymerizable compound, and an organic gelling agent.

7. A hologram recording method comprising:
irradiating an informing light and a reference light onto a hologram recording medium as a coaxial light beam, and
recording information on a hologram recording layer by means of an interference pattern formed by the interference between the informing light and the reference light,
wherein the hologram recording medium comprises a first substrate, a second substrate, and a hologram recording layer on the second substrate capable of recording information by means of holography, and
the hologram recording layer is formed from a composition for hologram recording media comprising a polymerizable monomer, a photopolymerization initiator, a non-polymerizable compound, and an organic gelling agent.

8. A hologram reproducing method for reproducing information, comprising:
irradiating a reference light onto an interference pattern of a hologram recording layer to which information is recorded by a hologram recording method,
wherein the hologram recording method is either a method comprising irradiating an informing light and a reference light onto a hologram recording medium, and recording information on a hologram recording layer by means of an interference pattern formed by the interference between the informing light and the reference light; or a method comprising irradiating an informing light and a reference light onto a hologram recording medium as a coaxial light beam, and recording information on a hologram recording layer by means of an interference pattern formed by the interference between the informing light and the reference light,
wherein the hologram recording medium comprises a first substrate, a second substrate, and a hologram recording layer on the second substrate capable of recording information by means of holography, and
the hologram recording layer is formed from a composition for hologram recording media comprising a polymerizable monomer, a photopolymerization initiator, a non-polymerizable compound, and an organic gelling agent.
